(19) United States
(12) Patent Application Publication
(10) Pub. No.: US 2024/0011752 A1
(43) Pub. Date: Jan. 11, 2024

(54) SYSTEMS AND METHODS TO MEASURE SPECIMEN DIMENSIONS

(71) Applicant: Illinois Tool Works Inc., Glenview, IL (US)

(72) Inventors: Benjamin Hollander, Wayland, MA (US); Adrian Riddick, Medfield, MA (US); Christopher Joyce, Braintree, MA (US); Philippe Levesque, Levis (CA)

(21) Appl. No.: 18/348,142

(22) Filed: Jul. 6, 2023

Related U.S. Application Data
(60) Provisional application No. 63/359,085, filed on Jul. 7, 2022.

(51) Int. Cl. G01B 5/06

(52) U.S. Cl. CPC G01B 5/06

(57) ABSTRACT

Example specimen measurement devices include a clamp; a single actuator configured to control the clamp to position a specimen with a clamping force; a measurement probe configured to contact the clamped specimen with a probing force; and a single position sensor configured to measure a dimension of the clamped specimen based on detecting a position of the measurement probe.

### RELATED APPLICATIONS

The present application claims the benefit of U.S. Provisional Patent Application Ser. No. 63/359,085, filed Jul. 7, 2022, entitled “SYSTEMS AND METHODS TO MEASURE SPECIMEN DIMENSIONS.” The entirety of U.S. Provisional Patent Application Ser. No. 63/359,085 is expressly incorporated herein by reference.

### TECHNICAL FIELD

The present disclosure generally relates to test specimen measurement systems and, more particularly, to systems and methods to measure specimen dimensions.

### BACKGROUND

Material testing systems, such as systems that test specimens for tension, compression, torsion, strain, displacement, and/or other properties, typically use the physical dimensions of the test specimens to determine the measurement result. Conventional measurements of the physical dimensions may involve calipers or similar devices.

Limitations and disadvantages of conventional and traditional approaches will become apparent to one of skill in the art, through comparison of such systems with the present disclosure as set forth in the remainder of the present application with reference to the drawings.

### BRIEF SUMMARY

The present disclosure is directed to systems and methods to measure specimen dimensions, substantially as illustrated by and/or described in connection with at least one of the figures, and as set forth more completely in the claims.

These and other advantages, aspects and novel features of the present disclosure, as well as details of an illustrated example thereof, will be more fully understood from the following description and drawings.

### BRIEF DESCRIPTION OF THE DRAWINGS

FIG. 1 shows an example of an automated test measurement system including a specimen measurement device, in accordance with aspects of this disclosure.

FIG. 2 is a perspective view of an example specimen measurement device that may be used to implement the specimen measurement device of FIG. 1.

FIG. 3 is a side elevation view of the specimen width meter of FIG. 2 in an open position.

FIG. 4 is a top view of the specimen width meter of FIG. 2 in the open position.

FIG. 5 is a top view of the specimen width meter of FIG. 2 in a fully clamped position.

FIG. 6 is a front elevation view of the specimen thickness meter of FIG. 2 in an open position.

FIG. 7 is a side elevation view of the specimen thickness meter of FIG. 2 in the open position.

FIG. 8 is a side elevation view of the specimen thickness meter of FIG. 2 in a fully clamped position.

FIG. 9 is a front elevation view of the specimen thickness meter of FIG. 2 in the fully clamped position.

FIG. 10 illustrates a flowchart of example machine readable instructions which may be executed by the example processing circuitry of FIG. 2 to perform a measurement process using the specimen measurement device of FIGS. 2-9.

FIGS. 11A, 11B, 11C, 11D, 11E, and 11F illustrate a sequence of actuations of the specimen measurement device of FIGS. 2-9 during performance of the example instructions of FIG. 10.

FIG. 12 is a block diagram of an example implementation of the computing device of FIG. 2.

The figures are not necessarily to scale. Where appropriate, the same or similar reference numerals are used in the figures to refer to similar or identical elements.

### DETAILED DESCRIPTION

Material testing systems are used to measure physical properties, such as tensile strength or compressive strength, of material specimens. To determine accurate measurements, the dimensions of the material specimen is also measured. Conventional specimen dimension measurements may occur manually (e.g., using calipers) or automatically. Certain standards, such as ASTM D5947-18, specify certain conditions under which the dimensions are to be measured. However, conventional manual methods are labor intensive, which can increase costs and decrease throughput for testing applications having high specimen volumes. Furthermore, conventional automatic measurement devices may have insufficient accuracy, small specimen dimension envelopes, and high cost.

Disclosed example specimen measurement devices align and center material specimens with the measurement axes over a range of specimen thicknesses and/or widths. In some disclosed examples, each measurement axis is actuated using a single motor and is measured using only a single encoder. Using a single motor and a single encoder per axis, disclosed example specimen measurement devices align and center the specimen with the measurement axes, firmly clamp the specimen in position, and apply a repeatable probing force for both axes. Disclosed example specimen measurement devices may be used as standalone measurement devices and/or as part of an automated material testing system.

Disclosed example specimen measurement devices include: a specimen width meter configured to measure a width dimension of a specimen, the specimen width meter including: a first measurement probe; a first clamp and a second clamp configured to, in response to actuation of at least one of the first clamp or the second clamp, clamp a specimen in alignment with the first measurement probe; a first actuator configured to actuate at least one of the first clamp or the second clamp; and a first position sensor configured to determine a location of the first measurement probe. The example specimen measurement devices further include a specimen thickness meter configured to measure a thickness dimension of a specimen, the specimen thickness meter including: a second measurement probe oriented perpendicularly to the first measurement probe; a third clamp and a fourth clamp configured to, in response to actuation of at least one of the third clamp or the fourth clamp, clamp the specimen in alignment with the second measurement probe; a second actuator configured to actuate at least one of the third clamp or the fourth clamp and the second measurement probe; and a second position sensor configured to determine a location of the second measurement probe. The example specimen measurement devices further include processing circuitry configured to: control the first actuator to clamp the first and second clamps on the specimen and to engage the first measurement probe with the specimen; control the second actuator to clamp the third and fourth clamps on the specimen and to engage the second measurement probe with the specimen; determine a width of the specimen based on the first position sensor; and determine a thickness of the specimen based on the second position sensor.

In some example specimen measurement devices, the first actuator includes a twin lead screw configured to actuate the first clamp and the first measurement probe in a first direction and actuate the second clamp in a second direction opposite the first direction. In some example specimen measurement devices, the first actuator further includes a motor configured to turn the twin lead screw, and the first sensor includes a current sensor configured to detect a motor current to determine whether the first force exceeds the first threshold force.

In some example specimen measurement devices, the first measurement probe includes a first spring configured to apply a predetermined engagement force on the first measurement probe toward the specimen. In some example specimen measurement devices, the specimen width meter is configured to constrain the specimen and clamp the specimen in a predetermined location with respect to the specimen thickness meter, for a range of specimen widths, using a single actuator.

In some example specimen measurement devices, the specimen width meter is configured to measure a width of the specimen in a horizontal direction. In some example specimen measurement devices, the first clamp includes first and second arms positioned on opposing sides of the first measurement probe. In some example specimen measurement devices, each of the specimen thickness meter and the specimen width meter include only one position sensor. In some example specimen measurement devices, the first clamp and the second clamp are configured to align the specimen with the second measurement probe.

In some example specimen measurement devices, the second actuator includes a twin lead screw configured to actuate the third clamp and the third measurement probe in a first direction and actuate the fourth clamp in a second direction opposite the first direction. In some example specimen measurement devices, the second actuator further includes a motor configured to turn the twin lead screw, and the second sensor includes a current sensor configured to detect a motor current to determine whether the second force exceeds the second threshold force.

In some example specimen measurement devices, the first clamp is positioned above the second clamp, the first clamp includes a first spring configured to provide a first clamping force and the second clamp includes a second spring configured to provide a second clamping force, and the second spring is preloaded such that the first clamp is configured to clamp the specimen to a support surface prior to engagement of the second clamp to the specimen and such that the second clamping force is greater than the first clamping force. Some example specimen measurement devices further include a support surface configured to position the specimen prior to measurement, and the second clamping force is set such that the second clamp raises the specimen above the support surface prior to engagement of the second measurement probe with the specimen. In some example specimen measurement devices, the second measurement probe is configured to engage the specimen after clamping of the specimen.

In some example specimen measurement devices, the specimen thickness meter is configured to constrain the specimen and clamp the specimen in a predetermined location, for a range of specimen thicknesses, using a single actuator. In some example specimen measurement devices, a clamping force between the first clamp and the second clamp is greater than a probing force between the first measurement sensor and the specimen. In some example specimen measurement devices, the specimen width meter further includes a third measurement probe opposite the first measurement probe, and the first position sensor is configured to measure the location of the first measurement probe with respect to the third measurement probe when the first measurement probe and the third measurement probe are each applying the probing force on the specimen.

In some example specimen measurement devices, a clamping force between the third clamp and the fourth clamp is greater than a probing force between the second measurement sensor and the specimen. In some example specimen measurement devices, the specimen width meter further includes a third measurement probe opposite the second measurement probe, and the second position sensor is configured to measure the location of the second measurement probe with respect to the third measurement probe when the second measurement probe and the third measurement probe are each applying the probing force on the specimen.

In some example specimen measurement devices, the processing circuitry is configured to: control the first actuator to clamp the first and second clamps on the specimen to align the specimen with the second measurement probe; control the second actuator to clamp the third and fourth clamps on the specimen; control the first actuator to unclamp the first and second clamps from the specimen in response to at least one of the third clamp or the fourth clamp clamping the specimen; control the second actuator to align the specimen with the first measurement probe via the third and fourth clamps, and to move the second measurement probe into contact with the specimen; and control the first actuator to clamp the first and second clamps on the specimen and to engage the first measurement probe with the specimen.

Some example specimen measurement devices further include: a first sensor configured to determine whether a first force on at least one of the first measurement probe, the first clamp, or the second clamp satisfies a first threshold force; and a second sensor configured to determine whether a second force on at least one of the second measurement probe, the third clamp, or the fourth clamp satisfies a second threshold force. In some example specimen measurement devices, the processing circuitry is configured to control at least one of the first actuator or the second actuator based on at least one of the first position sensor or the second position sensor. In some example specimen measurement devices, the specimen measurement device is configured to be added to a testing system.

Disclosed example specimen measurement devices include: a clamp; a single actuator configured to control the clamp to position a specimen with a clamping force; a measurement probe configured to contact the clamped specimen with a probing force; and a single position sensor configured to measure a dimension of the clamped specimen based on detecting a position of the measurement probe.

In some example specimen measurement devices, the single actuator, the measurement probe, and the single position sensor are configured to measure a width of the specimen. In some example specimen measurement devices, the single actuator includes a twin lead screw configured to actuate the clamp and the measurement probe in a first direction and actuate a second clamp in a second direction opposite the first direction.

In some example specimen measurement devices, the single actuator further includes a motor configured to turn the twin lead screw, and further includes a current sensor configured to detect a motor current to determine whether the first force exceeds the first threshold force. In some example specimen measurement devices, the measurement probe includes a spring configured to apply a predetermined engagement force on the measurement probe toward the specimen.

Some example specimen measurement devices further include processing circuitry configured to: control the single actuator to clamp the first and second clamps on the specimen and to engage the measurement probe with the specimen; and determine a width of the specimen based on the single position sensor.

In some example specimen measurement devices, the clamp is configured to constrain the specimen and clamp the specimen in a predetermined location with respect to a specimen thickness meter, for a range of specimen widths, using the single actuator. In some example specimen measurement devices, the first clamp comprises first and second arms positioned on opposing sides of the first measurement probe.

In some example specimen measurement devices, the single actuator, the measurement probe, and the single position sensor are configured to measure a thickness of the specimen. In some example specimen measurement devices, the single actuator comprises a twin lead screw configured to actuate the clamp and the measurement probe in a first direction and actuate a second clamp in a second direction opposite the first direction.

In some example specimen measurement devices, the second actuator further includes a motor configured to turn the twin lead screw, and the single position sensor includes a current sensor configured to detect a motor current to determine whether the second force exceeds the second threshold force. In some example specimen measurement devices, the clamp is positioned above a second clamp, the clamp comprises a first spring configured to provide a first clamping force and the second clamp comprises a second spring configured to provide a second clamping force, and the second spring is preloaded such that the clamp is configured to clamp the specimen to a support surface prior to engagement of the second clamp to the specimen and such that the second clamping force is greater than the first clamping force.

Some specimen measurement devices further include a support surface configured to position the specimen prior to measurement, and the second clamping force is set such that the second clamp raises the specimen above the support surface prior to engagement of the second measurement probe with the specimen. In some example specimen measurement devices, the second measurement probe is configured to engage the specimen after clamping of the specimen.

Disclosed example testing systems include: a specimen test device configured to determine at least one mechanical property of the specimen; and a specimen measurement device to measure at least one dimension of the specimen using a single actuator and a single position sensor per measured dimension.

In some such testing systems, the specimen measurement device is configured to measure at least one of a width of the specimen or a thickness of the specimen.

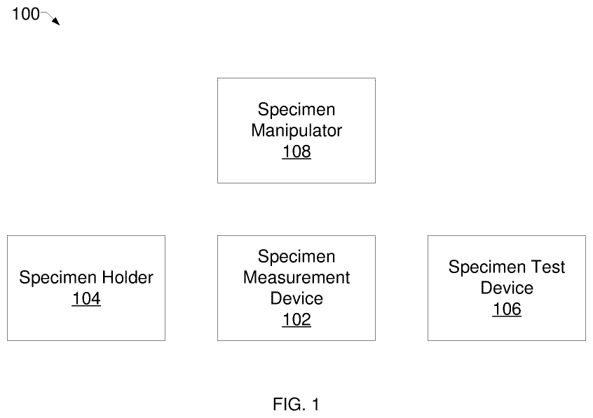

FIG. 1 shows an example of an automated test measurement system 100 including a specimen measurement device 102, as well as a specimen holder 104 and a specimen test device 106. The example automated test measurement system 100 further includes a specimen manipulator 108, such as a robotic arm, which moves test specimens between the specimen holder 104, the specimen measurement device 102, and the specimen test device 106.

The example specimen holder 104 may be a rack or similar device which may be loaded with specimens in a manner that is accessible to the manipulator 108. The example specimen test device 106 is configured to perform one or more mechanical or other tests on the test specimens in the specimen holder 104. For example, the specimen test device 106 may be a universal testing machine which performs tension strength testing, compression strength testing, torsion or bend testing, peel testing, tear testing, friction testing, shear testing, and/or any other type of testing. Example testing machine that may be used to implement the specimen test device 106 include the 6800 Series and/or 3400 Series testing system sold by Instron®, a division of Illinois Tool Works Inc., having a place of business in Norwood, MA.

In some examples, the specimen manipulator 108 removes a test specimen from the specimen holder 104 and places it in a predetermined position in the specimen measurement device 102. The specimen measurement device 102 measures the thickness and width of the specimen, as disclosed in more detail below. The specimen manipulator 108 may then remove the specimen from the specimen measurement device 102 and place the specimen in the specimen test device 106.

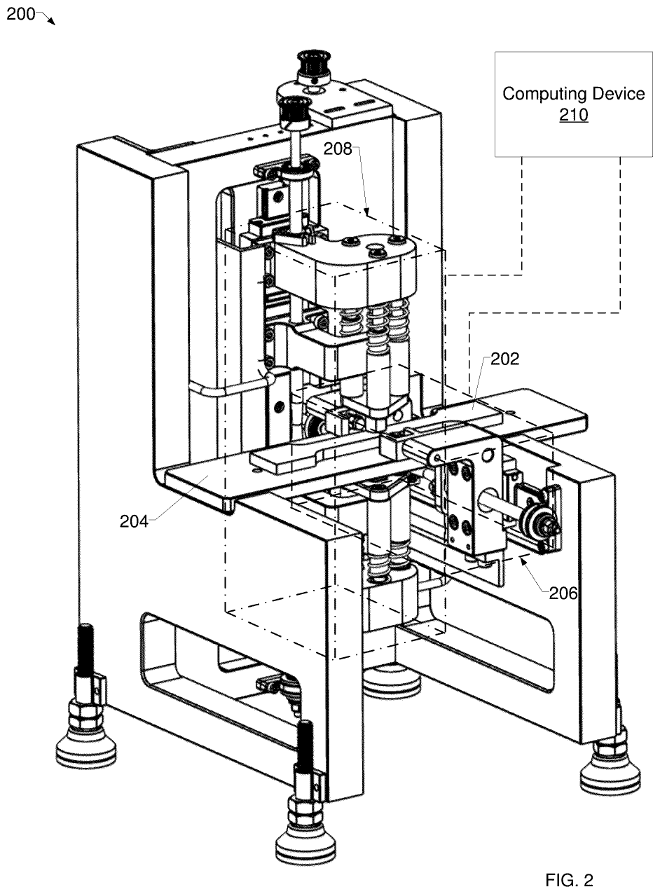

FIG. 2 is a perspective view of an example specimen measurement device 200 that may be used to implement the specimen measurement device 102 of FIG. 1. The example specimen measurement device 200 measures the cross-section dimensions (e.g., thickness and width) of a specimen 202 placed on a support surface 204 of the specimen measurement device 200. To this end, the example specimen measurement device 200 includes a specimen width meter 206 and a specimen thickness meter 208. Each of the specimen width meter 206 and the specimen thickness meter 208 includes clamps and measurement probes, as well as a sensor to detect clamping force and an encoder to perform position measurements.

As disclosed in more detail below, the example specimen measurement device 200 includes only one actuator per measurement axis, and uses mechanical sequencing for all alignment, constraint, and measurement steps. To comply with relevant measurement standards (e.g., ASTM D5947-18), the specimen measurement device 200 provides measurement force that is independent of clamping force, and uses electromechanical control and springs to provide precise, accurate, and repeatable control of clamping and positioning. The example specimen measurement device 200 centers or aligns the specimen along both measurement axes regardless of dimensions (within a measurement envelope). As a result, the specimen measurement device 200 is adaptable to many different specimens and geometries within the measurement envelope.

To implement the mechanical sequencing and performing the measurements, the example specimen measurement device 200 includes computing device 210, such as a computer or similar processing device, which controls the actuation of the specimen width meter 206 and the specimen thickness meter 208 and receives, processes, and/or stores sensor data associated with feedback and/or measurement inputs. The example computing device 210 may be a standalone computing device, integrated into the specimen measurement device 200, and/or part of another component of the system 100 (e.g., the specimen test device 106) in communication with the specimen measurement device 102.

The example specimen thickness meter 208 is provided with an asymmetric preload on the clamps of the specimen thickness meter 208, such that the top clamp always contacts first and clamps the specimen 202 to the support surface 204 before the bottom clamp lifts the specimen 202 off the support surface 204 to a predetermined measurement position. The clamping force provided by the specimen thickness meter 208 is proportional to the thickness of the specimen 202.

The example specimen width meter 206 and the specimen thickness meter 208 constrain the specimen 202 while reducing (e g, minimizing, eliminating) deformation and deflection of the specimen 202 during measurements, thereby reducing measurement error.

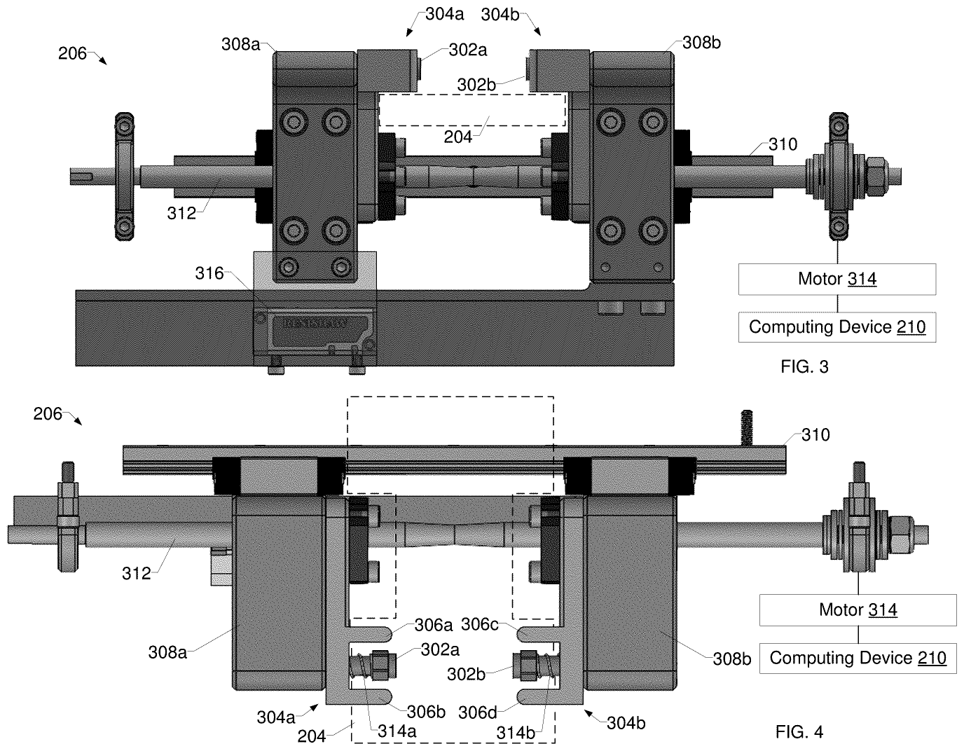

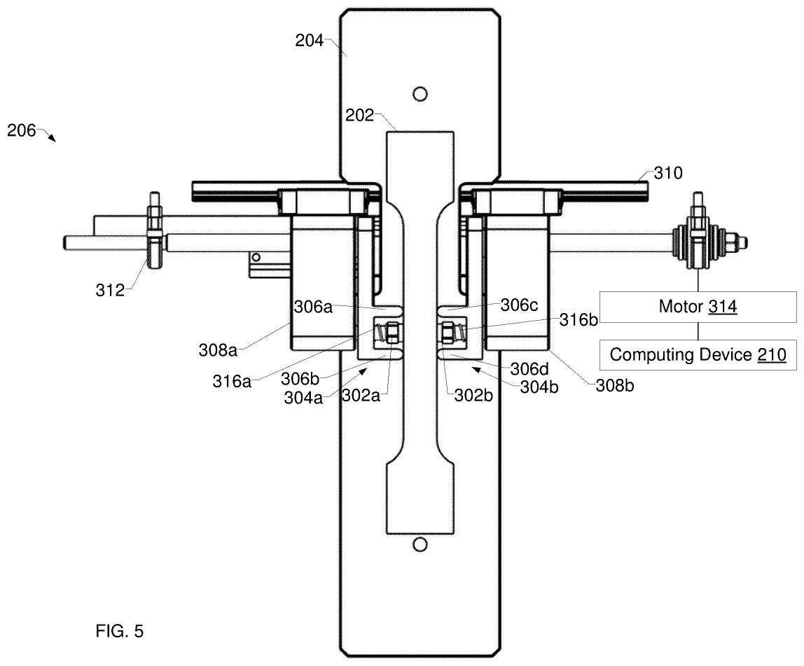

FIG. 3 is a side elevation view of the specimen width meter 206 of FIG. 2 in an open position. FIG. 4 is a top view of the specimen width meter 206 in the open position. FIG. 5 is a top view of the specimen width meter 206 in a fully clamped position. The specimen width meter 206 is illustrated with the support surface 204 and the specimen 202 of FIG. 2.

The example specimen width meter 206 includes measurement probes 302a, 302b and clamps 304a, 304b positioned on opposing sides of the support surface 204. The example clamps 304a, 304b of FIGS. 3-5 each include tamping arms 306a, 306b, 306c, 306d, and the measurement probes 302a, 302b are positioned between the respective pairs of the tamping arms 306a-306d.

The measurement probes 302a, 302b and the clamps 304a, 304b are mounted and supported via respective carriages 308a, 308b attached via bearings to a mounting rail 310. The measurement probes 302a, 302b and the clamps 304a, 304b are actuated simultaneously via a twin lead screw 312, which is driven via an electric motor 314 (e.g., directly, via a belt and pulley system, via a gear system, etc.). The twin lead screw 312 has threads that travel in opposing directions on different ends of the twin lead screw 312. When the twin lead screw 312 is turned, the twin lead screw 312 drives the carriages 308a, 308b and measurement arms in opposing directions (e.g., toward or away from each other, depending on the direction of actuation of the twin lead screw 312). However, in other examples the twin lead screw 312 may be replaced with a unidirectional lead screw and the carriages 308a, 308b may be provided with opposing thread directions.

The example measurement probes 302a, 302b extend through the clamps 304a, 304b (e.g., between the tamping arms 306a and 306b and the tamping arms 306c and 306d) to contact the specimen 202. The measurement probes 302a, 302b are provided with springs 314a, 314b, which provide a probing force on the measurement probes 302a, 302b for performing the measurements. The springs 314a, 314b are compressed between the measurement probes 302a, 302b and the clamps 304a, 304b. However, other resilient devices may be used in place of the springs 314a, 314b to provide the desired probing force.

In the example of FIGS. 3-5, an position sensor 316 determines a location of at least one of the measurement probes 302a, such as a distance between the two measurement probes 302a, 302b. For example, the position sensor 316 may be an encoder attached to the carriage 308a to determine a location along a measurement tape or spar coupled to the carriage 308b to determine the distance between the measurement probes 302a, 302b. Other example position sensors 316 may include capacitive sensors, linear variable displacement transducers (LVDTs), laser displacement sensors, and/or any other type of position sensor. In some examples, multiple measurements obtained by the position sensor 316 may be filtered (e.g., averaged) to determine the measured dimension. The position sensor 316 and/or the computing device 210 may communicate measurements to an external system for recording, specimen tracking, and/or any other purpose.

In some examples, the specimen width meter 206 further includes a force sensor to determine whether a probing force on one or both measurement probes 302a, 302b is within a predetermined force range. When the probing force is within the predetermined force range, the measurement output of the position sensor 316 may be determined and stored as the width of the specimen 202.

In operation, the twin lead screw 312 is actuated to close the clamps 304a, 304b on the specimen 202 on the support surface 204, which causes the clamps 304a, 304b to align the specimen 202 with the probes 302a, 302b and center the specimen 202 with the probes of the specimen thickness meter 208. FIG. 5 depicts the clamps 304a, 304b in the closed position. While the specimen 202 is on the support surface 204, the measurement probes 302a, 302b may not be in full or even partial contact the specimen 202, depending on the thickness of the specimen.

When the clamp 604a of the specimen thickness meter 208 has clamped the specimen 202 against the support surface 204, the example twin lead screw 312 may be actuated in the reverse direction to disengage the clamps 304a, 304b from the specimen 202. By disengaging the clamps 304a, 304b, the clamps of the specimen thickness meter 208 are permitted to raise the specimen 202 to a measurement position above the support surface 204. The twin lead screw 312 may then be actuated in the first direction to re-clamp the specimen 202 with the clamps 304a, 304b, and engage the measurement probes 302a, 302b with the probing force to perform the width measurement. The measurement probes 302a, 302b are moved into and out of contact with the specimen 202 as a result of movement by the clamps 304a, 304b and force applied against the measurement probes 302a, 302b by the springs 314a, 314b. When the clamps 304a, 304b are in contact with the specimen 202, the springs 314a, 314b provide a repeatable probing force, which is independent of the clamping force, to the measurement probes 302a, 302b against the specimen 202 (e.g., in accordance with relevant measurement standards).

At the conclusion of the measurement, the twin lead screw 312 is actuated in the reverse direction to unclamp the specimen 202 and to permit additional measurements and/or removal of the specimen 202 from the specimen measurement device 200 (e.g., for transfer to a specimen test device).

While the example specimen width meter 206 of FIGS. 3-5 includes two carriages 308a, 308b to support the clamps 304a, 304b and measurement probes 302a, 302b, in other examples the clamps 304a, 304b may be provided with carriages separate from carriages supporting the measurement probes 302a, 302b.

In some other examples, instead of having the clamps 304a, 304b actuated from opposing directions, the specimen width meter 206 may include one clamp coupled to an actuator (e.g., a lead screw) and a second clamp in a stationary position. In such examples, the specimen thickness meter 208 may also be configured to move with the actuated clamp of the specimen width meter 206, such that the specimen thickness meter 208 is aligned with the specimen 202 upon clamping of the specimen 202 by the specimen width meter 206.

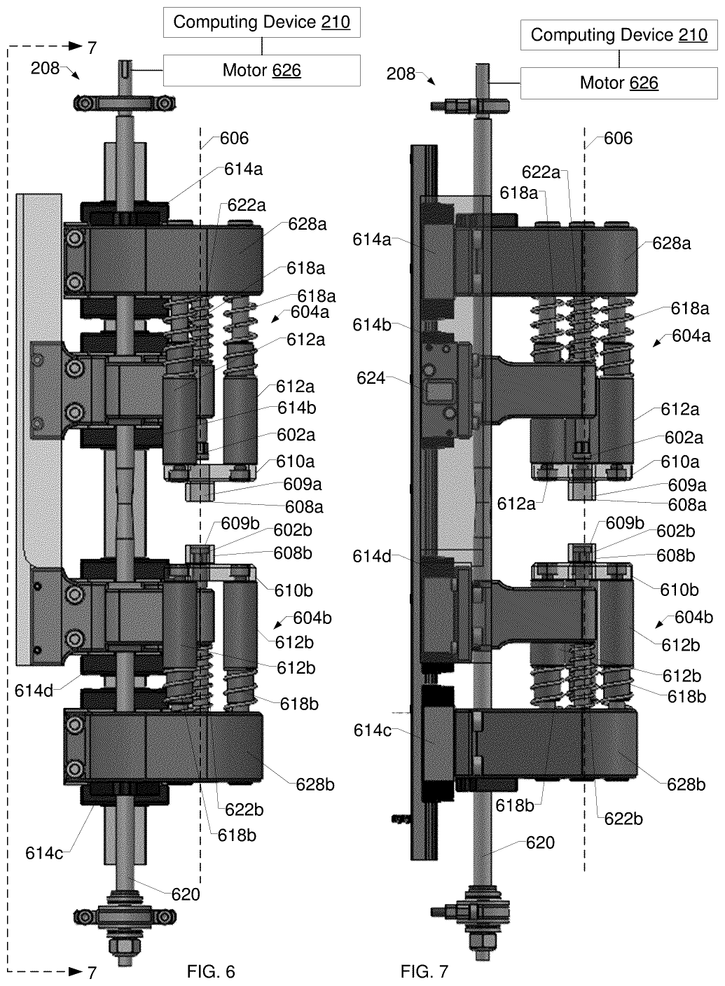

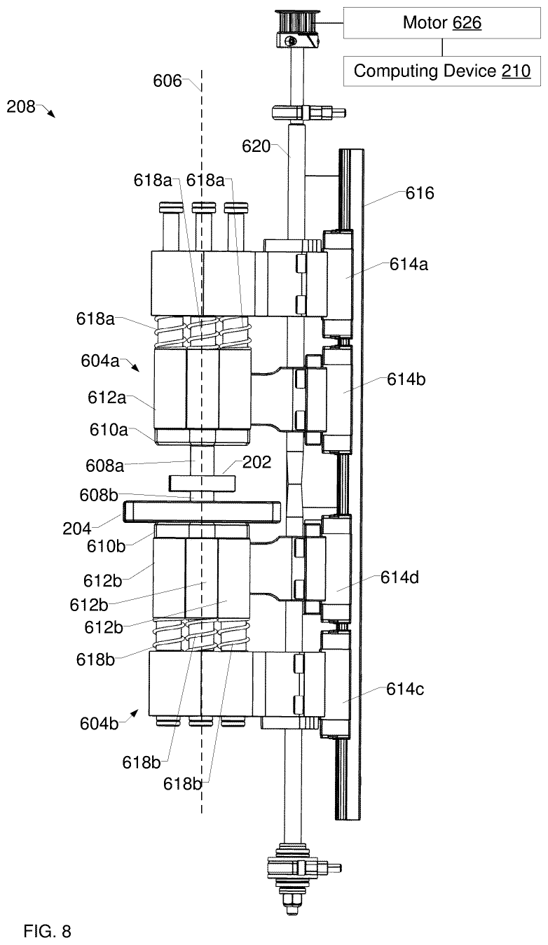

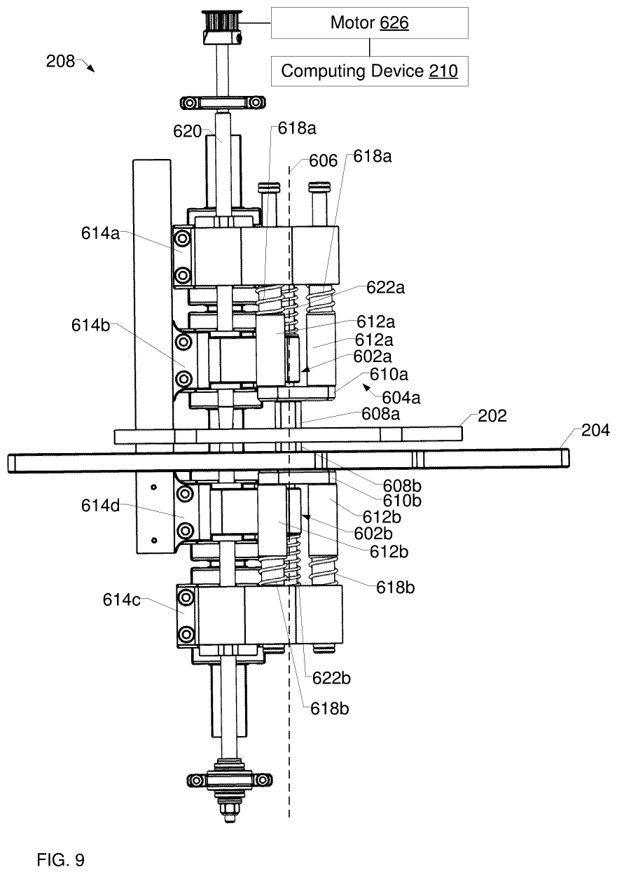

FIG. 6 is a front elevation view of the specimen thickness meter 208 of FIG. 2 in an open position. FIG. 7 is a side elevation view of the specimen thickness meter 208 in the open position. FIG. 8 is a side elevation view of the specimen thickness meter 208 in a fully clamped position, and FIG. 9 is a front elevation view of the specimen thickness meter 208 in the fully clamped position. As mentioned above, the specimen thickness meter 208 is operated in sequence with the specimen width meter 206 of FIGS. 3-5 to align, position, and measure the specimen 202.

The example specimen thickness meter 208 includes measurement probes 602a, 602b and clamps 604a, 604b. The measurement probes 602a, 602b and the clamps 604a, 604b are aligned with a measurement axis 606 of the specimen thickness meter 208, and the measurement probes 602a, 602b are configured to apply a probing force to the specimen 202 positioned on the support surface 204, which is also in alignment with the measurement axis 606 of the specimen thickness meter 208 due to the clamping by the clamps 304a, 304b.

The upper clamp 604a includes a clamping post 608a which is positioned at a center of a load balancing platform 610a. The load balancing platform 610a is coupled to three or more pistons 612a, which apply a balanced force to the load balancing platform 610a to reduce or eliminate moments on the specimen 202 by the upper clamp 604a. In some examples, the clamping post 608a and the load balancing platform 610a are implemented as a single integrated part. However, the clamping post 608a and the load balancing platform 610a may alternatively be assembled into a rigid assembly.

The pistons 612a are coupled to a carriage 614a, which is coupled to a mounting rail 616 via bearings to maintain alignment with the measurement axis 606. The pistons 612a are provided with corresponding springs 618a, which collectively apply a balanced clamping force to the heads of the pistons 612a and, as a result, to the load balancing platform 610a, the clamping post 608a, and the specimen 202.

The clamping post 608a has a bore 609a through which the measurement probe 602a extends to contact the specimen 202. The measurement probe 602a includes a spring 622a configured to provide a probing force on the measurement probe 602a that is within a predetermined range of probing forces, which may be the same or different as the range of probing forces on the measurement probes 302a, 302b. The measurement probe 602a is mounted to the mounting rail 616 via a separate carriage 614b, and the spring 622a is compressed between the measurement probe 602a and a body 628a of the clamp 604a, such that the probing force provided by the spring 622a is applied independently of the clamping force applied by the clamp 604a via the springs 618a. To this end, the twin lead screw 620 is coupled to the carriage 614a to control the clamp 604a, but is not directly coupled to the carriage 614b. The spring 622a provides the probing force to the measurement probe 602a via movement of the carriage 614a and pushing against the body 628a of the clamp 604a. In this manner, the probing force is established consistently and substantially independently of the clamping force applied by the clamp 604a.

The example lower clamp 604b is positioned on an opposing side of the specimen 202 from the upper clamp 604a, and includes similar components such as a clamping post 608b, a load balancing platform 610b, pistons 612b, and springs 618b, which are mounted to a carriage 614c. The load balancing platform 610b includes a bore 609b through which the measurement probe 602b extends to contact the specimen 202.

The measurement probe 602b includes a spring 622b configured to provide a probing force on the measurement probe 602b that is within a predetermined range of probing forces, which may be the same or different as the range of probing forces on the measurement probes 302a, 302b. The measurement probe 602b is mounted to the mounting rail 616 via a carriage 614d, and the spring 622b is compressed between the measurement probe 602b and a body 628b of the clamp 604b, such that the probing force provided by the spring 622b is applied independently of the clamping force applied by the clamp 604b via the springs 618b. The twin lead screw 620 is coupled to the carriage 614c to control the clamp 604b, but is not directly coupled to the carriage 614d. The spring 622b provides the probing force to the measurement probe 602b via movement of the carriage 614c and pushing against the body 628b of the clamp 604b. In this manner, the probing force is established consistently and substantially independently of the clamping force applied by the clamp 604b. Other resilient devices may be used in place of the springs 618a, 618b, 622a, 622b to provide the desired clamping and/or probing forces.

The carriages 614a-614d are driven by a twin lead screw 620 in a similar manner as the twin lead screw 312 and the carriages 308a, 308b of FIGS. 3-5. In the example of FIGS. 6-9, the carriages 614a, 614b (e.g., the upper measurement probe 602a and the upper clamp 604a) are driven in a first direction and the carriages 614c, 614d (e.g., the lower measurement probe 602b and the lower clamp 604b) are driven in a second direction opposite the first direction (e.g., to move the carriages 614a, 614b toward the carriages 614c, 614d) in response to turning of the twin lead screw 620 in a first direction. Turning of the twin lead screw 620 in the opposite direction causes motion in the reverse direction of the carriages 614a, 614b and the carriages 614c, 614d (e.g., to move the carriages 614a, 614b away from the carriages 614c, 614d).

The example specimen thickness meter 208 further includes an position sensor 624. In the example of FIGS. 3-5, the position sensor 624 determines a location of at least one of the measurement probes 602a, 602b, such as a distance between the two measurement probes 602a, 602b. For example, the position sensor 624 may be attached to the carriage 614c and determine a location along a measurement tape or spar coupled to the carriage 614d to determine the distance between the measurement probes 602a, 602b. In some examples, the specimen thickness meter 208 further includes a force sensor to determine whether a probing force on one or both measurement probes 602a, 602b is within a predetermined force range. When the probing force is within the predetermined force range, the measurement output of the position sensor 624 may be determined and stored as the thickness of the specimen 202. The position sensor 624 may be implemented according to any of the examples discussed above with reference to the position sensor 316.

The example twin lead screw 620 of FIGS. 6-9 is driven via an electric motor 626 (e.g., directly, via a belt and pulley system, via a gear system, etc.).

In the example of FIGS. 6-9, the lower clamp 604b is preloaded. For example, the pistons 612a and 612b may be implemented by screwing or bolting the pistons 612a, 612b to the carriages 614a, 614c such that the initial load on the springs 618a, 618b can be set by screwing or unscrewing the pistons 612a, 612b. By preloading the lower clamp 604b, the clamps 604a, 604b are configured to perform a sequence in which (in response to actuation via the twin lead screw 620) the upper clamp 604a contacts the specimen 202 (prior to contact by the lower clamp 604b), the lower clamp 604b contacts the specimen 202, and the preload on the lower clamp 604b causes the lower clamp 604b to raise the clamped specimen 202 above the support surface 204 as the forces between the lower clamp 604b and the upper clamp 604a partially or completely equalize.

The sequence further involves engagement of the measurement probes 602a, 602b with the specimen 202 after the clamps 604a, 604b have moved the specimen 202 into a measurement position (e.g., above the support surface 204). The clamps 604a, 604b also orient the specimen 202 orthogonal to the measurement probes 602a, 602b at the location of the probes 602a, 602b. The sequence may be coordinated with actuation of the probes 302a, 302b and/or the clamps 304a, 304b of the example specimen width meter 206. FIGS. 8 and 9 illustrate the example measurement probes 602a, 602b and clamps 604a, 604b in the fully closed position, in which the specimen 202 is in the measurement position.

While the examples of FIGS. 2-9 using twin lead screws, in other examples the twin lead screws may be replaced with other types of actuators, such as synchronous lever(s), pneumatic actuators, hydraulic actuators, opposed belt drives and/or gears, and/or any other type of actuators. Additionally or alternatively, while a single encoder per measurement axis is advantageous, one or both axes may use multiple encoders (e.g., one encoder per measurement probe) to perform the measurements.

In some examples, the specimen measurement device 200 may include a specimen detection sensor to automatically detect the presence of the specimen 202 (e.g., on the support surface 204). In some examples, the specimen detection sensor provides an output in response to detecting the specimen 202 in a measurement position. The output may cause an alert or other output to notify an operator that the specimen is detected and/or a measurement procedure is about to begin, and/or may trigger the initiation of a measurement sequence (e.g., via the computing device 210).

Additionally or alternatively, a specimen detection sensor may be interlocked with the actuators, such that detection of the specimen is required to permit actuation of the specimen measurement device 200. In some examples, the specimen detection sensor is configured to detect the presence of the specimen 202 in a manner that is not easily replicated by an operator's hands or other non-specimen objects, such as by image recognition and/or presence detection at multiple locations which are spaced apart.

In some examples, the support surface 204 may include a stage or other actuator which moves the support surface 204 along a length dimension of the aligned specimen (e.g., orthogonal to the axes of both the specimen width meter 206 and the specimen thickness meter 208). By moving the support surface 204 in the width dimension, the specimen measurement device 200 can take width and/or thickness measurements at multiple locations along a length of the specimen 202.

In some examples, the actuators (e.g., the motor 314, the motor 626) are further equipped with actuator force sensor(s) that detect when force(s) on one or both actuators are higher than a threshold force (e.g., higher than the configured clamping forces). Detection of forces above the threshold force may cause the computing device 210 to control the actuators (e.g., the motor 314, the motor 626) to stop and/or reverse direction.

In some examples, the computing device 210 may control the actuators (e.g., the motor 314, the motor 626) based on locations measurements from the position sensors 316, 624). For example, the computing device 210 may control a speed of the actuators (e.g., the motor 314, the motor 626) based on the location measurements, such as by operating the actuators at faster speeds at farther distances and at slower speeds as the position sensors 316, 624 detect that the clamps 304a, 304b and/or 604a, 604b are approaching the specimen 202. For example, the computing device 210 may have one or more distance or location thresholds that control speed ranges used to control the actuators. Additionally or alternatively, when the specimen 202 is clamped, the computing device 210 may limit the distance moved by the clamps 304a, 304b and/or 604a, 604b after unclamping the specimen 202 when a subsequent clamping (e.g., a subsequent measurement) is to occur for the same specimen 202. By controlling the actuator based on the locations detected by the position sensors 316, 624, disclosed examples may reduce the time involved in obtaining specimen measurements.

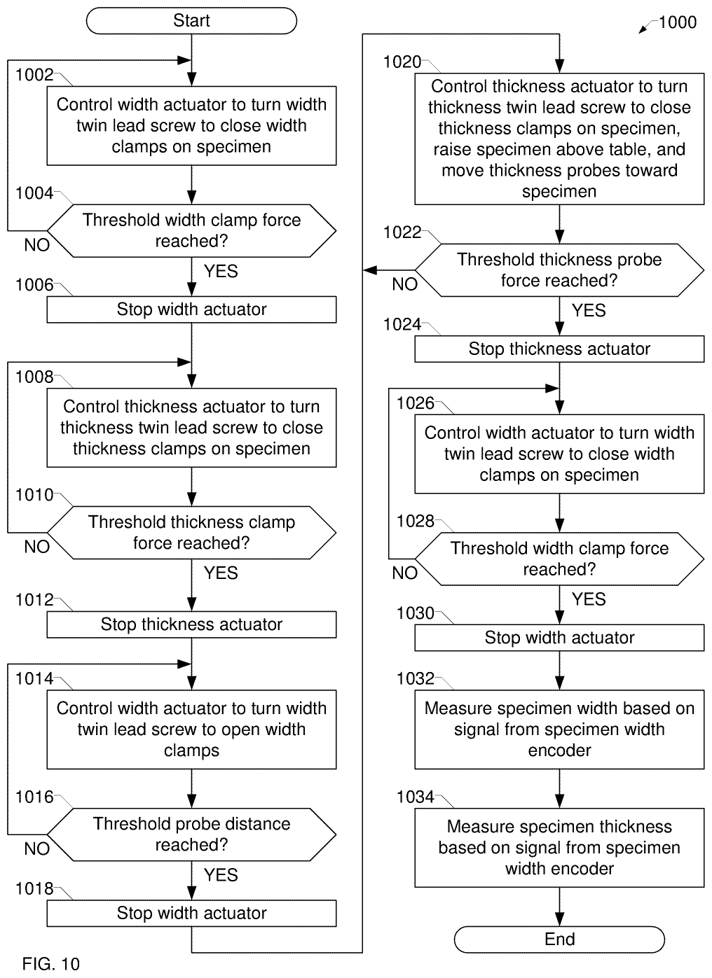

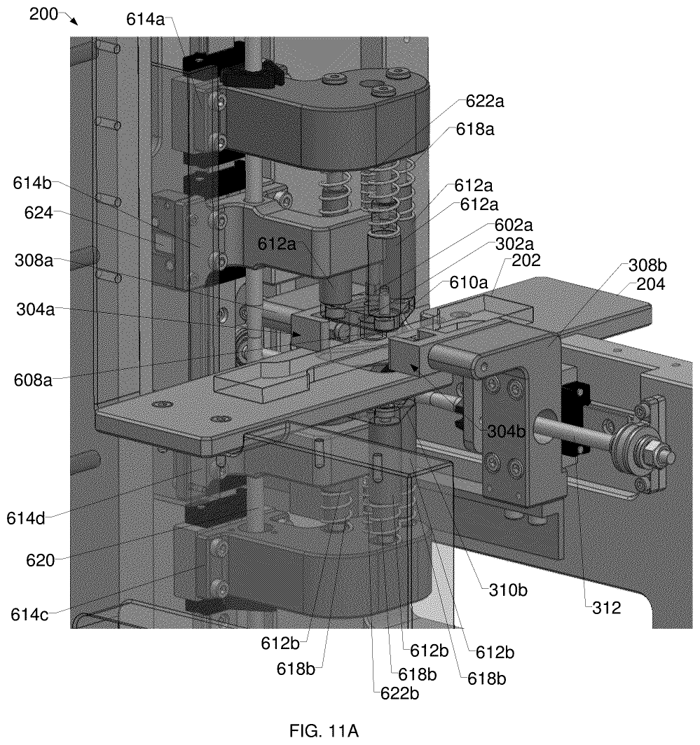

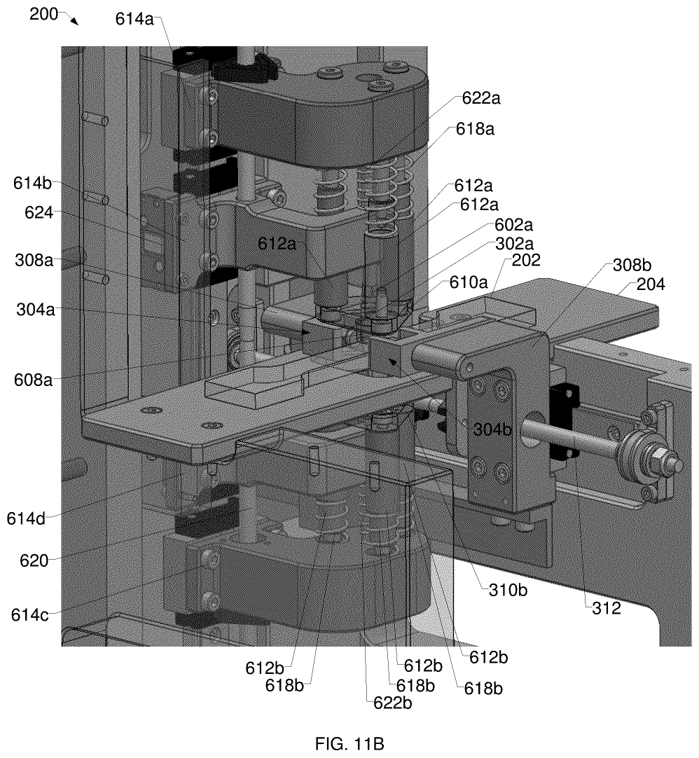

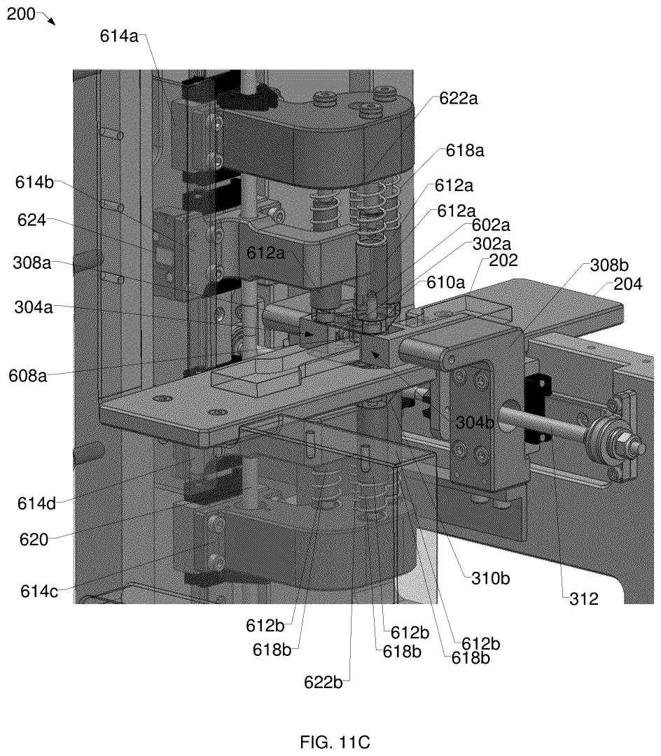

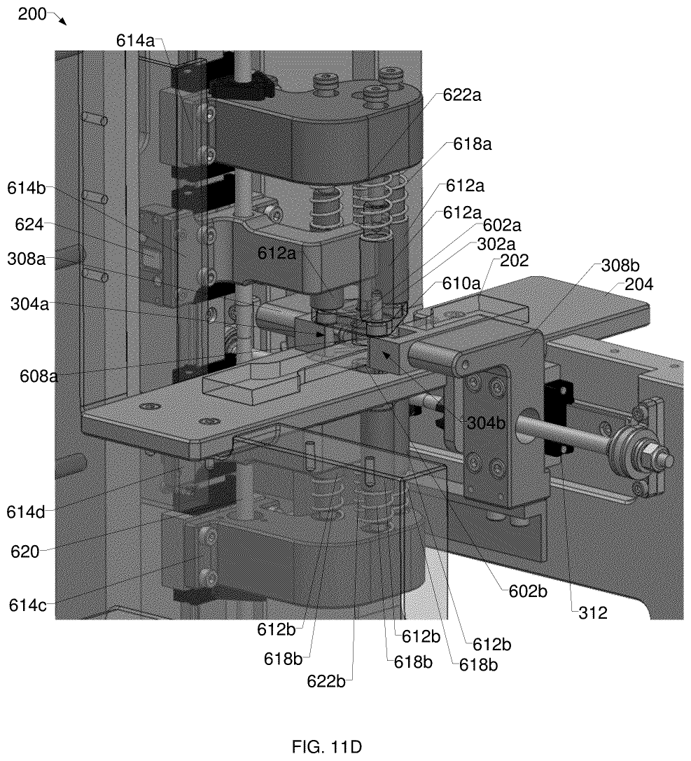

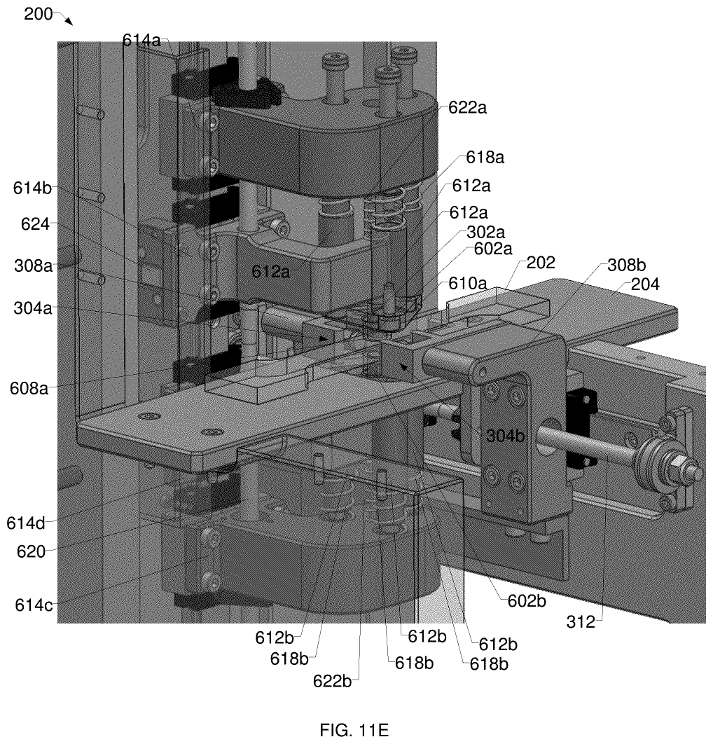

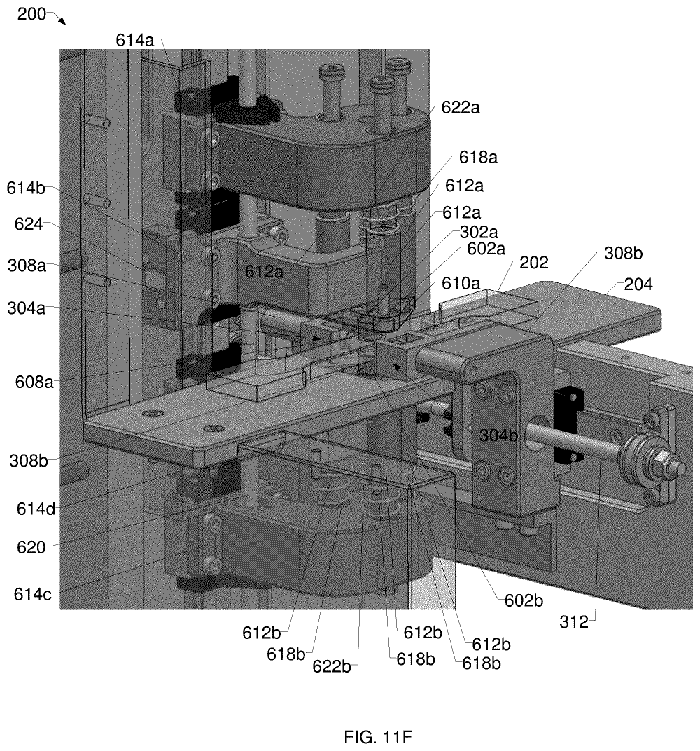

FIG. 10 illustrates a flowchart of example machine readable instructions which may be executed by the example computing device 210 of FIG. 2 to perform a measurement process using the specimen measurement device 200 of FIGS. 2-9. The example instructions 1000 are discussed below with reference to a sequence of actuations of the specimen measurement device 200 illustrated in FIGS. 11A-11F. FIG. 11A illustrates the specimen width meter 206 and the specimen thickness meter 208 in an initial, open position in which the specimen 202 may be placed onto the support surface 204.

At block 1002, the computing device 210 controls a width actuator (e.g., the motor 314 of FIG. 3) to turn the width twin lead screw (e.g., the twin lead screw 312) to close width clamps (e.g., clamps 304a, 304b, tamping arms 306a-306d) on a specimen (e.g., the specimen 202 positioned on the support surface 204).

At block 1004, the computing device 210 determines whether a threshold width clamp force has been reached. For example, the computing device 210 may read a motor current of the motor 314 to determine an amount of force between applied by the clamps 304a, 304b. If the threshold width clamp force has not been reached (block 1004), control returns to block 1002 to continue closing the width clamps 304a, 304b.

If the threshold width clamp force has been reached (block 1004), at block 1006 the computing device 210 stops the width actuator (e.g., the motor 314). FIG. 11B illustrates the example specimen measurement device 200 at the completion of block 1006, when the width clamps 304a, 304b are clamped on the specimen 202.

At block 1008, the computing device 210 controls the thickness actuator (e.g., the motor 626 of FIG. 6) to turn the thickness twin lead screw (e.g., the twin lead screw 620 of FIG. 6) to close the thickness clamps (e.g., clamps 604a, 604b of FIG. 6) on the specimen 202.

At block 1010, the computing device 210 determines a threshold thickness clamp force has been reached. For example, the computing device 210 may monitor a current sensor coupled to measure the current in the motor 626 to determine the load or force on the clamps 604a, 604b. If the threshold thickness clamp force has not been reached (block 1010), control returns to block 1008 to continue closing the clamps 604a, 604b.

If the threshold thickness clamp force has been reached (block 1010), at block 1012 the computing device 210 stops the motor 626. FIG. 11C illustrates the example specimen measurement device 200 at the completion of block 1012, when the thickness clamps 604a, 604b are clamped on the specimen 202.

At block 1014, the computing device 210 controls the width actuator (e.g., the motor 314) to turn the width lead screw 312 to open the width clamps 304a, 304b. The actuation in block 1014 is an opposite direction to the actuation of block 1002.

At block 1016, the computing device 210 determines whether a threshold probe distance has been reached. For example, the computing device 210 may determine based on the position sensor 316 that the carriages 308a, 308b have increased in distance by at least a threshold amount from block 1006, and/or that the carriages 308a, 308b are at least a threshold distance apart. If the threshold probe distance has not been reached (block 1016), control returns to block 1014 to continue controlling the width actuator (e.g., the motor 314).

When at least the threshold probe distance has not been reached (block 1016), At block 1018 the computing device 210 stops the width actuator (e.g., the motor 314). FIG. 11D illustrates the example specimen measurement device 200 at the completion of block 1016, when the width clamps 304a, 304b have unclamped from the specimen 202.

At block 1020, the computing device 210 control the thickness actuator (e.g., the motor 626) to turn the thickness twin lead screw 620 to close the thickness clamps 604a, 604b on the specimen 202, raise the specimen 202 above the support surface 204 (e.g., when at least a threshold clamping force has been reached based on the thickness of the specimen 202), and move the thickness probes 602a, 602b toward the specimen 202 (e.g., when the specimen 202 has been raised above the support surface 204 due to equalization in clamping force by the clamps 604a, 604b). FIG. 11E illustrates the example specimen measurement device 200 at the completion of block 1020, when the thickness clamps 604a, 604b have clamped the specimen 202 and raised the specimen 202 above the support surface 204, and the thickness probes 602a, 602b have engaged the specimen 202.

At block 1022, the computing device 210 determines whether a threshold thickness probe force has been reached. For example, the computing device 210 may determine that when at least a threshold clamping force has been reached (e.g., based on a current of the motor 626), the threshold probe force has been reached. Additionally or alternatively, the computing device 210 may receive measurements from a force sensor configured to read the force on one or both of the measurement probes 602a, 602b. If the threshold thickness probe force has not been reached (block 1022), control returns to block 1020 to continue controlling the thickness actuator (e.g., the motor 626). When the threshold thickness probe force has been reached (block 1022), at block 1024 the computing device 210 stops the thickness actuator (e.g., the motor 626).

At block 1026, the computing device 210 controls the width actuator (e.g., the motor 314) to turn the width twin lead screw 312 to close the width clamps 304a, 304b on the specimen 202. FIG. 11F illustrates the example specimen measurement device 200 at the completion of block 1026, when the width clamps 304a, 304b have clamped the specimen 202, the width probes 302a, 302b have engaged the specimen 202.

At block 1028, the computing device 210 determines whether the threshold width clamp force has been reached. Block 1028 may be performed in a similar or identical manner as block 1004. If the threshold width clamp force has not been reached (block 1028), control returns to block 1026 to continue controlling the width actuator (e.g., motor 314). When the threshold width clamp force is reached (block 1028), at block 1030 the computing device 210 stops the width actuator (e.g., motor 314).

At block 1032, the computing device 210 measures the width of the specimen 202 based on a signal from the specimen width position sensor 316. At block 1034, the computing device 210 measures the thickness of the specimen 202 based on a signal from the specimen thickness position sensor 624. The position sensors 316, 624 may be calibrated to convert a measured position or distance to a corresponding distance between the probes 302a, 302b or 602a, 602b, which may be further based on a measured probe force via force sensors coupled to the probes 302a, 30b and/or the probes 602a, 602b.

The example instructions 1000 then end. In some examples, the computing device 210 may control the actuators (e.g., motors 314, 626) to reverse the sequence to return the specimen 202 to the table and unclamp the specimen 202 for removal of the specimen 202 (e.g., manually and/or via the specimen manipulator 108).

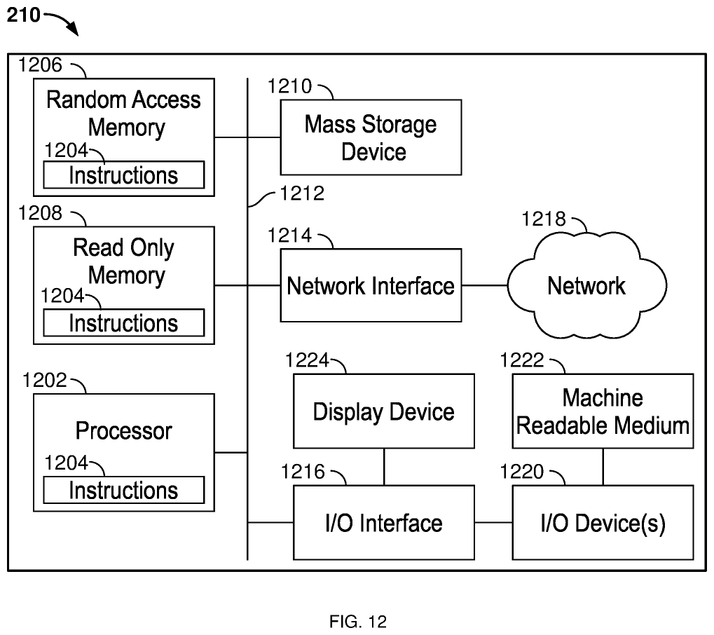

FIG. 12 is a block diagram of an example implementation of the computing device 210 of FIG. 2. The example computing device 210 may be a general-purpose computer, a laptop computer, a tablet computer, a mobile device, a server, an all-in-one computer, and/or any other type of computing device.

The example computing device 210 of FIG. 12 includes a processor 1202. The example processor 1202 may be any general purpose central processing unit (CPU) from any manufacturer. In some other examples, the processor 1202 may include one or more specialized processing units, such as RISC processors with an ARM core, graphic processing units, digital signal processors, and/or system-on-chips (SoC). The processor 1202 executes machine readable instructions 1204 that may be stored locally at the processor (e.g., in an included cache or SoC), in a random access memory 1206 (or other volatile memory), in a read only memory 1208 (or other non-volatile memory such as FLASH memory), and/or in a mass storage device 1210. The example mass storage device 1210 may be a hard drive, a solid state storage drive, a hybrid drive, a RAID array, and/or any other mass data storage device.

A bus 1212 enables communications between the processor 1202, the RAM 1206, the ROM 1208, the mass storage device 1210, a network interface 1214, and/or an input/output interface 1216.

The example network interface 1214 includes hardware, firmware, and/or software to connect the computing device 210 to a communications network 1218 such as the Internet. For example, the network interface 1214 may include IEEE 1202.X-compliant wireless and/or wired communications hardware for transmitting and/or receiving communications.

The example I/O interface 1216 of FIG. 12 includes hardware, firmware, and/or software to connect one or more input/output devices 1220 to the processor 1202 for providing input to the processor 1202 and/or providing output from the processor 1202. For example, the I/O interface 1216 may include a graphics processing unit for interfacing with a display device, a universal serial bus port for interfacing with one or more USB-compliant devices, a FireWire, a field bus, and/or any other type of interface. The example computing device 210 includes a display device 1224 (e.g., an LCD screen) coupled to the I/O interface 1216. Other example I/O device(s) 1220 may include a keyboard, a keypad, a mouse, a trackball, a pointing device, a microphone, an audio speaker, a display device, an optical media drive, a multi-touch touch screen, a gesture recognition interface, a magnetic media drive, and/or any other type of input and/or output device.

The example computing device 210 may access a non-transitory machine readable medium 1222 via the I/O interface 1216 and/or the I/O device(s) 1220. Examples of the machine readable medium 1222 of FIG. 12 include optical discs (e.g., compact discs (CDs), digital versatile/video discs (DVDs), Blu-ray discs, etc.), magnetic media (e.g., floppy disks), portable storage media (e.g., portable flash drives, secure digital (SD) cards, etc.), and/or any other type of removable and/or installed machine readable media.

Disclosed example specimen measurement devices may be built into or integrated with testing systems, and/or may be implemented as an add-on module to a testing system. For example, example specimen measurement devices disclosed herein may be implemented on a same frame as a universal testing device or other testing system, such that a same computing device or other processing and/or control circuitry controls both specimen measurement processes and specimen testing processes. Alternatively, disclosed example specimen measurement devices may be attached or placed near the testing system for ease of access and transfer of specimens between the specimen measurement device as the testing system.

The present methods and/or systems may be realized in hardware, software, or a combination of hardware and software. The present methods and/or systems may be realized in a centralized fashion in at least one computing system, or in a distributed fashion where different elements are spread across several interconnected computing and/or remote computing systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip. Some implementations may comprise a non-transitory machine-readable (e.g., computer readable) medium (e.g., FLASH drive, optical disk, magnetic storage disk, or the like) having stored thereon one or more instructions (e.g., lines of code) executable by a machine, thereby causing the machine to perform processes as described herein.

As utilized herein, the terms “e.g.,” and “for example” set off lists of one or more non-limiting examples, instances, or illustrations.

As used herein, the terms “coupled,” “coupled to,” and “coupled with,” each mean a structural and/or electrical connection, whether attached, affixed, connected, joined, fastened, linked, and/or otherwise secured. As used herein, the term “attach” means to affix, couple, connect, join, fasten, link, and/or otherwise secure. As used herein, the term “connect” means to attach, affix, couple, join, fasten, link, and/or otherwise secure.

As used herein the terms “circuits” and “circuitry” refer to physical electronic components (i.e., hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, circuitry is “operable” and/or “configured” to perform a function whenever the circuitry comprises the necessary hardware and/or code (if any is necessary) to perform the function, regardless of whether performance of the function is disabled or enabled (e.g., by a user-configurable setting, factory trim, etc.).

As used herein, a control circuit may include digital and/or analog circuitry, discrete and/or integrated circuitry, microprocessors, DSPs, etc., software, hardware and/or firmware, located on one or more boards, that form part or all of a controller, and/or are used to control a welding process, and/or a device such as a power source or wire feeder.

As used herein, the term “processor” means processing devices, apparatus, programs, circuits, components, systems, and subsystems, whether implemented in hardware, tangibly embodied software, or both, and whether or not it is programmable. The term “processor” as used herein includes, but is not limited to, one or more computing devices, hardwired circuits, signal-modifying devices and systems, devices and machines for controlling systems, central processing units, programmable devices and systems, field-programmable gate arrays, application-specific integrated circuits, systems on a chip, systems comprising discrete elements and/or circuits, state machines, virtual machines, data processors, processing facilities, and combinations of any of the foregoing. The processor may be, for example, any type of general purpose microprocessor or microcontroller, a digital signal processing (DSP) processor, an application-specific integrated circuit (ASIC), a graphic processing unit (GPU), a reduced instruction set computer (RISC) processor with an advanced RISC machine (ARM) core, etc. The processor may be coupled to, and/or integrated with a memory device.

As used, herein, the term “memory,” “memory circuitry,” and/or “memory device” means computer hardware or circuitry to store information for use by a processor and/or other digital device. The memory, memory circuitry, and/or memory device can be any suitable type of computer memory or any other type of electronic storage medium, such as, for example, read-only memory (ROM), random access memory (RAM), cache memory, compact disc read-only memory (CDROM), electro-optical memory, magneto-optical memory, programmable read-only memory (PROM), erasable programmable read-only memory (EPROM), electrically-erasable programmable read-only memory (EEPROM), a computer-readable medium, or the like. Memory can include, for example, a non-transitory memory, a non-transitory processor readable medium, a non-transitory computer readable medium, non-volatile memory, dynamic RAM (DRAM), volatile memory, ferroelectric RAM (FRAM), first-in-first-out (FIFO) memory, last-in-first-out (LIFO) memory, stack memory, non-volatile RAM (NVRAM), static RAM (SRAM), a cache, a buffer, a semiconductor memory, a magnetic memory, an optical memory, a flash memory, a flash card, a compact flash card, memory cards, secure digital memory cards, a microcard, a minicard, an expansion card, a smart card, a memory stick, a multimedia card, a picture card, flash storage, a subscriber identity module (SIM) card, a hard drive (HDD), a solid state drive (SSD), etc. The memory can be configured to store code, instructions, applications, software, firmware and/or data, and may be external, internal, or both with respect to the processor.

As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations.

While the present methods and/or systems have been described with reference to certain implementations, it will be understood by those skilled in the art that various changes may be made, and equivalents may be substituted without departing from the scope of the present method and/or system. For example, blocks and/or components of disclosed examples may be combined, divided, re-arranged, and/or otherwise modified. In addition, many modifications may be made to adapt a particular situation or material to the teachings of the present disclosure without departing from its scope. Therefore, the present methods and/or systems are not limited to the particular implementations disclosed. Instead, the present methods and/or systems will include all implementations falling within the scope of the appended claims, both literally and under the doctrine of equivalents.

1. A specimen measurement device, comprising:
a clamp;
a single actuator configured to control the clamp to position a specimen with a clamping force;
a measurement probe configured to contact the clamped specimen with a probing force; and
a single position sensor configured to measure a dimension of the clamped specimen based on detecting a position of the measurement probe.

2. The specimen measurement device of claim 1, wherein the single actuator, the measurement probe, and the single position sensor are configured to measure a width of the specimen.

3. The specimen measurement device as defined in claim 2, wherein the single actuator comprises a twin lead screw configured to actuate the clamp and the measurement probe in a first direction and actuate a second clamp in a second direction opposite the first direction.

4. The specimen measurement device as defined in claim 3, wherein the single actuator further comprises a motor configured to turn the twin lead screw, and further comprising a current sensor configured to detect a motor current to determine whether the first force exceeds the first threshold force.

5. The specimen measurement device as defined in claim 2, wherein the measurement probe comprises a spring configured to apply a predetermined engagement force on the measurement probe toward the specimen.

6. The specimen measurement device as defined in claim 2, further comprising processing circuitry configured to:
control the single actuator to clamp the first and second clamps on the specimen and to engage the measurement probe with the specimen; and
determine a width of the specimen based on the single position sensor.

7. The specimen measurement device as defined in claim 2, wherein the clamp is configured to constrain the specimen and clamp the specimen in a predetermined location with respect to a specimen thickness meter, for a range of specimen widths, using the single actuator.

8. The specimen measurement device as defined in claim 2, wherein the first clamp comprises first and second arms positioned on opposing sides of the first measurement probe.

9. The specimen measurement device of claim 1, wherein the single actuator, the measurement probe, and the single position sensor are configured to measure a thickness of the specimen.

10. The specimen measurement device as defined in claim 9, wherein the single actuator comprises a twin lead screw configured to actuate the clamp and the measurement probe in a first direction and actuate a second clamp in a second direction opposite the first direction.

11. The specimen measurement device as defined in claim 10, wherein the second actuator further comprises a motor configured to turn the twin lead screw, and the single position sensor comprises a current sensor configured to detect a motor current to determine whether the second force exceeds the second threshold force.

12. The specimen measurement device as defined in claim 10, wherein the clamp is positioned above a second clamp, the clamp comprises a first spring configured to provide a first clamping force and the second clamp comprises a second spring configured to provide a second clamping force, and the second spring is preloaded such that the clamp is configured to clamp the specimen to a support surface prior to engagement of the second clamp to the specimen and such that the second clamping force is greater than the first clamping force.

13. The specimen measurement device as defined in claim 12, further comprising a support surface configured to position the specimen prior to measurement, and the second clamping force is set such that the second clamp raises the specimen above the support surface prior to engagement of the second measurement probe with the specimen.

14. The specimen measurement device as defined in claim 12, wherein the second measurement probe is configured to engage the specimen after clamping of the specimen.

15. A specimen measurement device, comprising:
a specimen width meter configured to measure a width dimension of a specimen, the specimen width meter comprising:
a first measurement probe;
a first clamp and a second clamp configured to, in response to actuation of at least one of the first clamp or the second clamp, clamp a specimen in alignment with the first measurement probe;
a first actuator configured to actuate at least one of the first clamp or the second clamp; and
a first position sensor configured to determine a location of the first measurement probe;
a specimen thickness meter configured to measure a thickness dimension of a specimen, the specimen thickness meter comprising:
a second measurement probe oriented perpendicularly to the first measurement probe;
a third clamp and a fourth clamp configured to, in response to actuation of at least one of the third clamp or the fourth clamp, clamp the specimen in alignment with the second measurement probe;
a second actuator configured to actuate at least one of the third clamp or the fourth clamp and the second measurement probe; and
a second position sensor configured to determine a location of the second measurement probe; and
processing circuitry configured to:
control the first actuator to clamp the first and second clamps on the specimen and to engage the first measurement probe with the specimen;
control the second actuator to clamp the third and fourth clamps on the specimen and to engage the second measurement probe with the specimen;
determine a width of the specimen based on the first position sensor; and
determine a thickness of the specimen based on the second position sensor.

16. The specimen measurement device as defined in claim 15, wherein the first actuator comprises a twin lead screw configured to actuate the first clamp and the first measurement probe in a first direction and actuate the second clamp in a second direction opposite the first direction.

17. The specimen measurement device as defined in claim 16, wherein the first actuator further comprises a motor configured to turn the twin lead screw, and the first sensor comprises a current sensor configured to detect a motor current to determine whether the first force exceeds the first threshold force.

18. The specimen measurement device as defined in claim 15, wherein the first measurement probe comprises a first spring configured to apply a predetermined engagement force on the first measurement probe toward the specimen.

19. The specimen measurement device as defined in claim 15, wherein the specimen width meter is configured to constrain the specimen and clamp the specimen in a predetermined location with respect to the specimen thickness meter, for a range of specimen widths, using a single actuator.

20. The specimen measurement device as defined in claim 15, wherein the specimen width meter is configured to measure a width of the specimen in a horizontal direction.

21-39. (canceled)
